(19) United States
(12) Patent Application Publication
(10) Pub. No.: US 2011/0174277 A1
(43) Pub. Date: Jul. 21, 2011

(54) UNIVERSAL HYDROGEN PLASMA CARBURETOR

(76) Inventor: BERT SOCOLOVE, Howell, NJ (US)

(21) Appl. No.: 12/690,815

(22) Filed: Jan. 20, 2010

(51) Int. Cl. F02M 27/00; F01N 5/02; C25B 9/00

(52) U.S. Cl. 123/538; 60/320; 204/273

(57) ABSTRACT

Herein is described a device for pretreating fuel to provide a suitable fuel for combustion in a fuel burning apparatus having a fuel intake system and an exhaust system, the device comprising: a volatilization chamber for volatilizing the fuel in the volatilization chamber; a heated processor tube through which the volatilized fuel flows; a processor rod mounted in the processor tube around which the volatilized fuel flows as it flows through a reactor tube; a space between the processor rod and the heated processor tube through which the volatilized fuel flows forming a reaction zone thereby creating reacted fuel; and inlet means for directing the reacted fuel into the intake system of the fuel burning apparatus.

### BACKGROUND OF THE INVENTION

The present invention generally relates to a plasma hydrogen carburetor and a hydrogen plasma generating system where the hydrogen plasma created from the plasma hydrogen generator is converted into mechanical energy with the use of an internal combustion engine.

Plasma being the fourth state of matter, hydrogen plasma is formed when a gas (steam) or liquid composed of H₂O is exposed to a high temperature or strong electric field in a near vacuum with negatively charged hydrogen electrons, atoms or molecules, and positively charged ions left behind. The negative electrons and positive ions in hydrogen plasma interact through electric forces, so they feel and influence each other creating a magnetic field. While plasma has properties of a gas (its mass or field can be squeezed and expanded) it is also electrically conductive, like a metal.

As can be seen, there is a need for a universal hydrogen plasma generator to create fuel for internal combustion engines.

### SUMMARY OF THE INVENTION

In one aspect of the present invention, a device for pretreating fuel to provide a suitable fuel for combustion in a fuel burning apparatus having a fuel intake system and an exhaust system, the device comprises: a volatilization chamber for volatilizing the fuel in the volatilization chamber; a heated processor tube through which the volatilized fuel flows; a magnetic rod mounted in the processor tube around which the volatilized fuel flows as it flows through a reactor tube; a space between the magnetic rod and the heated processor tube through which the volatilized fuel flows forming a reaction zone thereby creating reacted fuel; and inlet means for directing the reacted fuel into the intake system of the fuel burning apparatus.

In another aspect of the present invention, a pretreater device for pretreating an alternate fuel to provide a suitable fuel for an internal combustion engine, the internal combustion engine having a fuel intake system and an exhaust system, the device comprises: an exhaust conduit having a first end and a second end, the first end being connected in fluid communication with the exhaust system of the internal combustion engine to receive exhaust from the internal combustion engine; an exhaust plenum at the second end of the exhaust conduit; a volatilization chamber interposed in the exhaust plenum, the volatilization chamber receiving thermal energy from an exhaust passing through the exhaust plenum; volatilization means for volatilizing the fuel in the volatilization chamber; exhaust bypass means for diverting a portion of the exhaust from the exhaust conduit through the alternate fuel; removal means for removing the volatilized fuel from the volatilization chamber; a reactor tube mounted in the exhaust conduit through which the volatilized alternate fuel flows; a magnetic rod mounted in the processor tube around which the volatilized fuel flows as it flows through the processor tube, the space between the magnetic rod and the processor tube through which the volatilized fuel flows forming a reaction zone; and inlet means for directing the reacted fuel into the intake system of the internal combustion engine.

Yet another aspect of the present invention provides a method for pretreating a fuel and water to make it usable in fuel burning equipment comprising the steps of selecting a fuel, placing the fuel in a volatilization chamber, volatilizing the fuel, pretreating the volatilized fuel by passing the volatilized fuel through a processor tube with a magnetic rod mounted therein to form a reaction zone between the magnetic rod and the processor tube, the reactor tube being heated to produce a plasma fuel; and accelerating the plasma fuel into the internal combustion engine through the use of a magnetic field generated by a solenoid around the processor tube.

These and other features, aspects and advantages of the present invention will become better understood with reference to the following drawings, description and claims.

### BRIEF DESCRIPTION OF THE DRAWINGS

FIG. 1 is a diagram of the plasma carburetor and pretreating apparatus according to an embodiment of this invention;

FIG. 2 is a schematic flow diagram of an exemplary embodiment of the processor;

FIG. 3A depicts an exemplary embodiment of a pressure steamer system;

FIG. 3B depicts an exemplary embodiment of a steamer chamber without a float;

FIG. 4 is a diagram showing systems combined to make a complete plasma carburetor processor according to an embodiment of the invention;

FIG. 5 is a diagram of an exemplary embodiment of different magnetic rods that are in the inner processor chamber;

FIG. 6 is a diagram of an exemplary embodiment of the cyclonic activator inside of the intake of the inner processor chamber inside of the main vortex chamber;

FIG. 7 is a diagram of an exemplary embodiment of a solenoid, a long cylinder wound with magnetic coils made up of wire producing a field;

FIG. 8 is a diagram of an exemplary embodiment of a duel (tandem) carburetion system that can be used instead of the steamer;

FIGS. 9A and 9B show an exemplary embodiment of a sonic generator; and

FIG. 10 shows an exemplary embodiment of a magnetic flux generator.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a hydrogen plasma carburetor. Where a typical four-stroke combustion engine cycle comprises 1) induction where the fuel enters the reaction chamber, 2) compression, 3) ignition where the fuel is burned, and 4) emission of the exhaust, the instant device can have a four-stroke cycle comprising 1) induction where a plasma enters the reaction chamber, 2) implosion where the plasma collapses, 3) explosion in reaction to the implosion, and 4) emission of the exhaust.

The device can allow formation of a hydrogen plasma from the thermal dynamic heat effect of the exhaust gases in a low-pressure vacuum vessel as water (steam) combined with petroleum based fuels or hydrocarbon based multi-fuels is drawn into the inner processor chamber from the vacuum created from the down stroke of the piston of an internal combustion engine. The thermal conductivities of the outer processor chamber from the exhaust gases of the exhaust manifold of the internal combustion engine can be thermally inducted into the inner processor chamber as the water (steam) and fuel or multi-fuels migrate past the nose of the magnetic processor rod and onto the main body of the magnetic processor rod and between the inner walls of the inner processor chamber. The thermal dynamic heat effect can initiate the breakdown (cracking) of the water to its basic elements, hydrogen plus oxygen. Through the thermal dynamic heat effect, petroleum based fuels or hydrocarbon based multi-fuels can be simultaneously broken down (cracked) to their basic elements such as hydrogen, oxygen and carbon where such fuels realize their full potentials. The hydrogen-catalyst gas mixture can continue its further migration to the tail of the magnetic processor rod where a low-pressure vacuum (for example 8-10 inches of mercury) can exist created from the down stroke of the piston of an internal combustion engine. In this low-pressure vacuum at the tail of the processor rod and thermodynamic equilibrium, the hydrogen plasma field can be created through the intake conduit of the inner processor chamber. The hydrogen plasma can be drawn into the piston cylinder where a low-pressure vacuum can be created from the down stroke of the piston. The up stroke of the piston of the compression stroke can create a high pressure on the outside field of the hydrogen plasma causing the collapse or implosion of the hydrogen plasma field. A vacuum can be created in the void where the hydrogen plasma existed creating a mechanical force on the piston drawing the piston up.

The hydrogen plasma carburetor can be a pretreating apparatus and method for pretreating fuel and alternative fuels allowing the fuel to be utilized more efficiently. The hydrogen plasma carburetor can reduce the consumption of fuel, and also can reduce the hydrocarbons, carbon monoxide and nitrous oxide that emanate from the exhaust. The hydrogen plasma carburetor can render multiple fuels usable as the fuel source for fuel burning equipment such as internal combustion engines, furnaces, boilers, and turbines.

An embodiment of the hydrogen plasma carburetor comprises a three part system:

A) The main processor chamber that comprises an inner and outer chamber with a magnetic rod inside of inside chamber,
B) a high pressure steamer or duel (tandem) carburetion system, and
C) a magnetic flux generator and/or the sonic generator.

Each system of the three part system that makes up the plasma carburetor can be used independently of each other.

The present invention can be a fuel pretreater apparatus and method for fuel burning equipment. This fuel pretreater can enable the fuel burning equipment to utilize as fuels combustible products selected from material such as water, steam, crude oil based products or alcohols, and the like. This fuel can be introduced as a liquid vapor into a volatilization chamber. The volatilization chamber may be heated to aid in volatilization and in most cases may be advantageously heated by thermal energy from the exhaust in the exhaust conduit of the fuel burning equipment. A portion of the exhaust may even be bubbled through the steamer. The fuel vapor produced in the volatilization chamber can be drawn through a cyclonic activator, then heated in the thermal processor. The thermal pretreater may be mounted, preferably concentrically, inside the exhaust conduit to be heated by the exhaust gases.

The thermal pretreater can serve as a processor and can be configured as a processor tube having a processor rod mounted, preferably concentrically, therein with a reduced annular space (gap) surrounding the rod. For small engines an exemplary gap size can be about 1 mm. For larger engines of typical size for a car, an exemplary gap size can be about 1.5 to 2 mm. The volatilized fuel can pass through this annular space where it can be subjected to thermal pretreatment prior to being introduced into the intake as a plasma where the fuel burning equipment or engine uses the plasma as fuel.]

The magnetic processor rod can have specific designs to it. A reason for the magnetic processor rod design can be to create a hydrogen plasma field. The designs of the magnetic processor rod can allow for the intake gasses to spin the magnetic processor rod. Vacuum can be applied to the tail of the magnetic processor rod from the internal combustion engine intake stroke. External heat can be applied to the inside chamber from the exhaust gases. Magnetically compressed vapors can develop greater temperatures. Vapors can become ionized. The initial remnant magnetic field can deflect the ionized vapors into a vortex. The vortexing ionized vapors (hydrogen plasma field) can create their own magnetic field that can add to the original fields making the overall magnetic field much more intense. This magnetic field can interact with the magnetic flux generator that can be placed over the processes chamber.

An embodiment of the present invention can be an apparatus and method for pretreating fuel for fuel burning with water for equipment such as internal combustion engines, furnaces, boilers, turbines, etc. The pretreatment can make it possible to use these fuels. The fuel is typically hydrocarbon such as crude oil based or recycled material such as motor oil, solvents, paint thinners, or various alcohols for example. The fuel can be introduced into a volatilization chamber and can be then subjected to a high temperature environment in a heated reaction chamber prior to its being introduced into the intake system of the fuel burning equipment. The reaction chamber can provide a heated reaction zone with a magnetic processor rod therein about which the fuel flows. It is this flow through the heated reaction zone where the fuel and water are turned into a plasma. The magnetic processor rod can make the fuel suitable for burning in the fuel burning equipment. The magnetic processor rod size with water as fuel can be a 32 mm vertical rod or a 64 mm horizontal rod. The magnetic processor rod size with gasoline as fuel can be a 92 mm vertical rod or a 184 mm horizontal rod. The magnetic processor rod size with diesel as fuel can be a 115 mm vertical rod or a 229 mm horizontal rod. The magnetic processor rod size with crude oil as fuel can be a 156 mm vertical rod or a 305 mm horizontal rod. In most cases, since the fuel burning equipment involved can produce high temperature exhaust gases, in order to save energy, the heating for the reaction chamber can be provided by the exhaust gases from the fuel burning equipment.

The reaction chamber can thus usually be positioned in the exhaust conduit, whether in an exhaust pipe, flue, chimney, etc., leading from the fuel burning equipment. It is believed important that the fuel flow through the reaction chamber be opposite the flow of exhaust gas in the exhaust conduit so that the most intense heating of the reaction chamber is at the end thereof where the fuel exits the reaction chamber, as larger fuel molecules are broken down into smaller molecular subunits of the heavy molecules including, for example, hydrogen, oxygen and carbon.

When the reaction chamber is heated by exhaust gases from the engine, in order to generate sufficient thermal energy it is necessary to volatilize the alternate fuel in the volatilization chamber.

The heat in the inner processor chamber with the magnetic processor rod can be sufficient to turn the incoming fuel and steam into a glowing plasma that is necessary to operate the internal combustion engine initially using ordinary gasoline. Water is cracked around 800 degrees Celsius where it is converted into hydrogen and oxygen. This step can be important since, absent the instant pretreatment process, it can be inefficient to operate an internal combustion engine with the alternate fuels herein described. Accordingly, the internal combustion engine can be started and operated for an initial period until sufficient thermal energy has been generated in order to initiate the volatilization and the pretreatment processes.

Once these processes are self sustaining, the fuel system can be switched over from the gasoline system to the alternate fuel system. The internal combustion engine can continue to operate for as long as the alternate fuel is supplied or until the internal combustion engine is switched off.

Similarly, with other fuel burning equipment, when the reaction chamber is positioned in the exhaust conduit, conventional fuels can be supplied to the equipment upon start-up and until sufficient thermal energy is supplied to the reaction chamber to produce fuel usable in the equipment from the alternate fuel.

The invention will be illustrated and described in detail with respect to an embodiment thereof for use with an internal combustion engine.

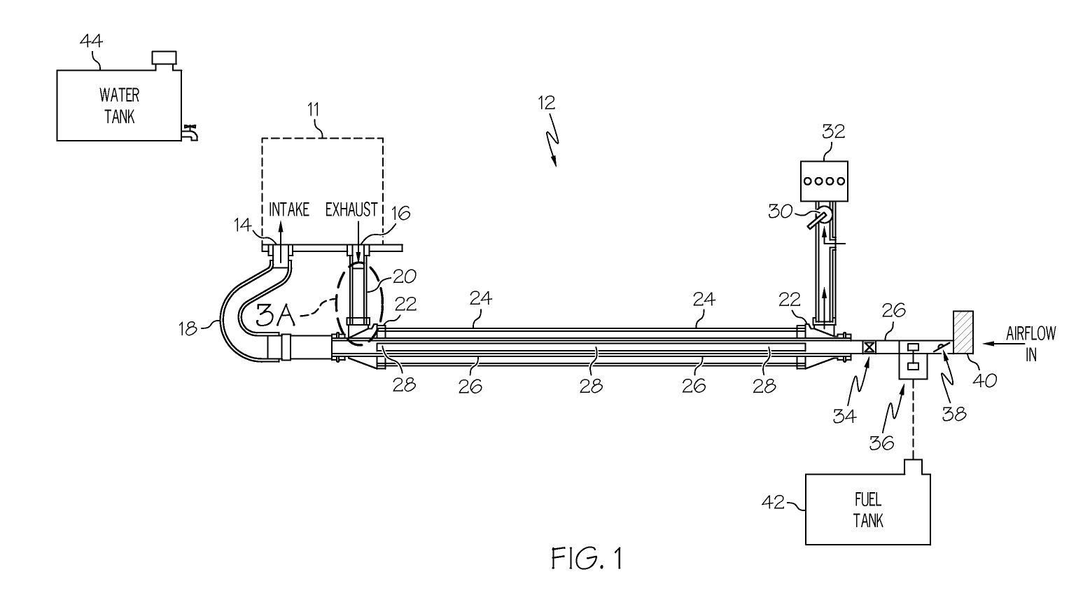

FIG. 1 shows an embodiment of the main processor chamber (12) that comprises an inner (26) and outer chamber (24) with a magnetic processor rod (28) inside of the inner chamber (26). Elements include intake chamber (14) of internal combustion engine (11), exhaust chamber (16) of internal combustion engine (11), direct through intake conduit (18), a reducing tee (22) that can allow for the flow-through separation of the inner (26) and outer processor chamber (24) where the exhaust can be flowing in the outer chamber (24) and the intake can be flowing in the inner chamber (26) in opposite directions, outer processor chamber (24), inner processor chamber (26), magnetic processor rod (28) inside of the inner processor chamber (26), ball valve (30) used to control the exhaust gases. By controlling the exhaust gases one can control the amount of exhaust gases going into the steamer (48), muffler attached to exhaust pipe (32), primary cyclonic activator (34) installed inside of the inner processor chamber (26), steamer diffuser (36) where the supercharged steam can enter the inner processor chamber (26) from the steamer (48), fuel atomizer (38) such as a carburetor, sonicator, or fuel injector or any type of unit used to atomize the fuel in inner processor chamber (26), air filter (40).

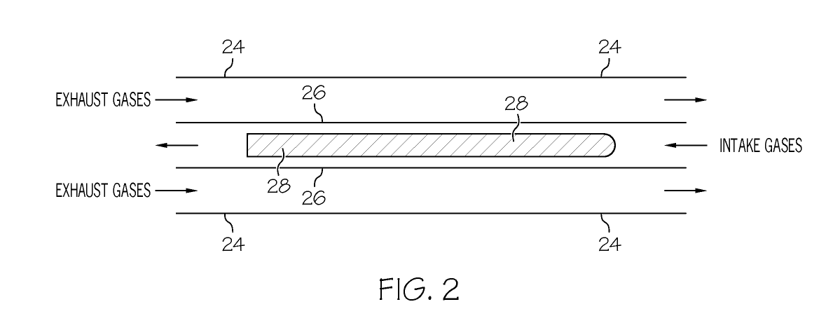

Elements in FIG. 2 include an outer processor chamber (24), an inner processor chamber (26), and a magnetic processor rod (28) inside of the inner processor chamber (26).

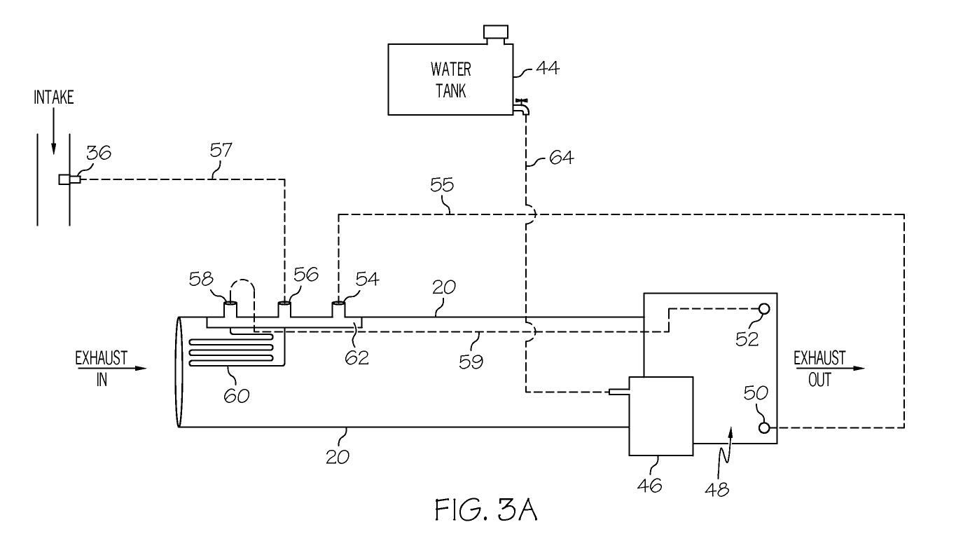

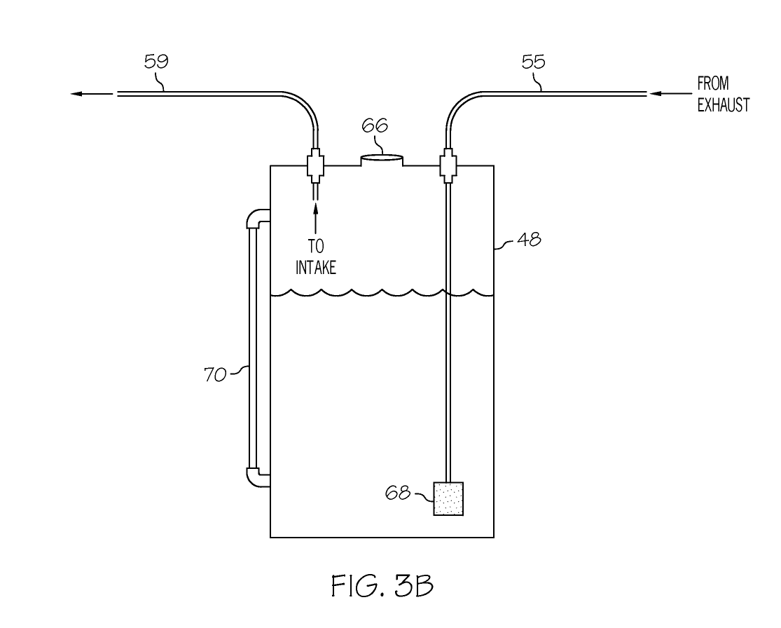

Elements in FIG. 3A include an exhaust conduit (20), a float chamber (46) that can be external or internal and is used to control the water level in the steamer chamber (48), a steamer chamber (48) connected to the exhaust conduit (20), a port (50) in the steamer chamber (48) where the exhaust gases can enter the steamer chamber (48) from the exhaust conduit (20) through a connecting conduit pipe (55), a port (52) in the steamer chamber (48) where the steam from the steamer chamber (48) can go through a connecting conduit pipe (59) to a heat exchanger (60) that has been placed inside of the exhaust conduit (20), a connecting conduit pipe (55) that can allow for transfer of hot exhaust gases from the exhaust conduit port (54) to the steamer chamber (48), a connecting conduit pipe (57) that can be attached to the heat exchanger port (56) that can be in the exhaust conduit (20) on one end and that can go to the steam diffuser (36) on the other side that can be attached to the inner processor chamber (26) that can be the intake of the processor, a connecting conduit pipe (59) that can take the steam from port (52) and brings it into the heat exchanger (60) through port (58), a heat exchanger (60) that can be in the exhaust conduit (20), a heat exchanger bracket (62) that can be connected to the out side of the exhaust conduit (20) and can be used to keep all three ports (54, 56, 58) together and hold the heat exchanger (60) in place, a water tank (44) and a connecting conduit pipe (64) that can bring water from the water tank (44) to float chamber (46), a steam diffuser (36) that can be inside the inner processor chamber (26) that can allow the steam to flow in the same direction as the incoming fuel and air mix, with a connecting conduit pipe (57) that can be connected to the port (56) that can be connected to the outgoing steam from the heat exchanger (60).

FIG. 3B illustrates an embodiment of a steamer chamber without a float. Elements can include a water fill hole (66), a pipe or tube (55) bringing the exhaust gases into the steamer chamber (48) connected by a fitting on the steamer chamber top, an aquarium-type air bubbler (68) on the bottom of the steamer chamber (48) connected by a hose to part (55), a see-through hose (70) allowing the viewing of the water level in the steamer chamber (48) when a solid chamber is used, and a hose (59) bringing a vapor-saturated mist to the intake of the processor chamber.

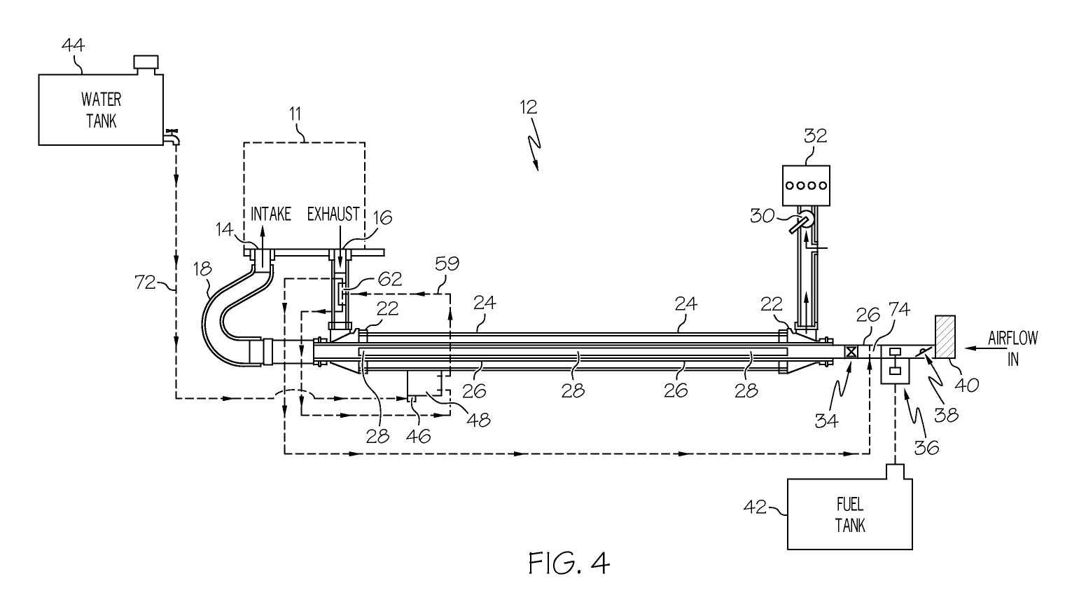

FIG. 4 shows an embodiment of the main processor chamber (12) comprising an inner (26) and outer processor chamber (24) with a magnetic processor rod (28) inside of the inner processor chamber (26) including the elements intake chamber (14) of internal combustion engine (11), exhaust chamber (16) of internal combustion engine (11), direct through intake conduit (18), a reducing tee (22) that can allow for the flow-through separation of the inner (26) and outer processor chamber (24) where the exhaust can be flowing in the outer processor chamber (24) and the intake can be flowing in the inner processor chamber (26) in opposite directions, ball valve (30) used to control the exhaust gases such that one can control the amount of exhaust gases going into the steamer chamber (48), muffler attached to the exhaust pipe (32), primary cyclonic activator (78) installed inside of the inner processor chamber (26), steamer diffuser (36) where the supercharged steam can enter the inner processor chamber (26) from the steamer chamber (48), fuel atomizer (38) such as a carburetor, sonic, or fuel injector or any type of unit used to atomize the fuel in the inner processor chamber (26), air filter (40), steamer chamber (48) connected to the exhaust conduit (20) through connecting conduit pipe (59), float chamber (46) can be external or internal and is used to control the water level in the steamer chamber (48), a water tank (44) and a connecting conduit pipe (72) that can bring water from the water tank (44) to the float chamber (46), a bracket (62) that can be connected to the outside of the exhaust conduit (20) and can be used to keep all three ports (54, 56, 58) together and hold the heat exchanger (60) in place, internal steam diffuser (36) that can be inside the inner processor chamber (26) that can allow the steam to flow in the same direction as the incoming fuel and air mix, with a connecting conduit pipe (57) that can be connected to the port (56) that can be connected to the outgoing steam from the heat exchanger (60).

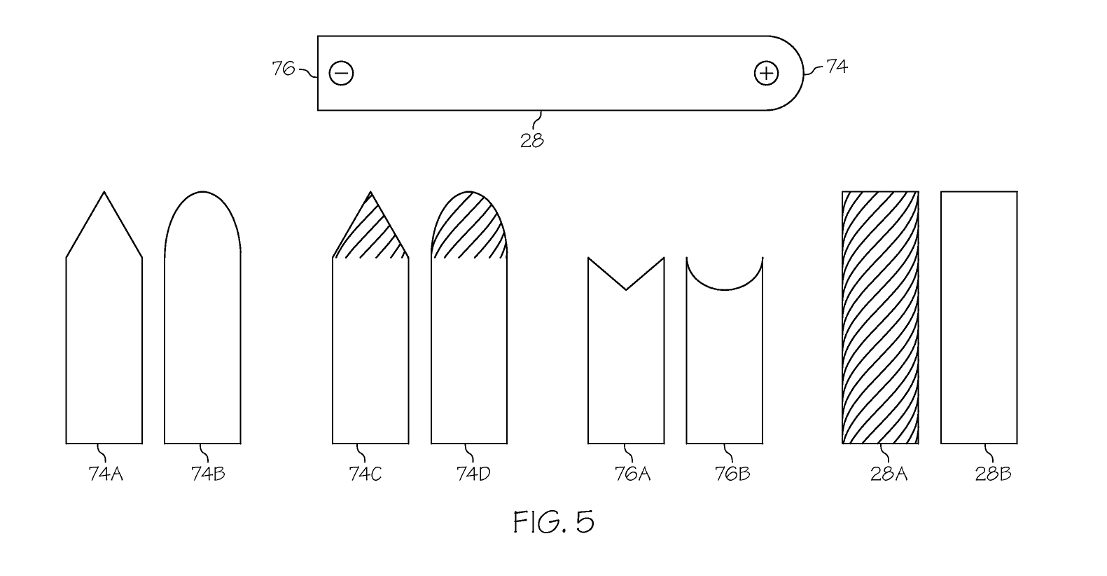

Elements in FIG. 5 include the body of the magnetic rod (28). The rod is pre-magnetized, can be made of steel or alloy with high magnetic permeability, and the nose of the rod can have a positive magnetic charge. The tail of the rod (28) can have a negative magnetic charge. The rod (28) can be of different lengths or sizes around the middle, the nose and tail can be of different sizes and shapes. All shapes can be mixed and matched. Exemplary different shapes of the nose of the rod (28) include pointed nose (74A), rounded nose (74B), pointed nose with centrifugal grooves (74C) to add to the cyclonic effect of the cyclonic activator (the grooves can be either clockwise or counterclockwise), or a rounded nose with centrifugal grooves (74D) to add to the cyclonic affect of the cyclonic activator (the grooves can be either clockwise or counterclockwise). Exemplary different shapes of the tail (76) of the rod (28) include a tail that has a point going in like a funnel (76A) or going to a point on the inside of the rod (28), or a tail that is concave (76B). The body of the processor rod (28) can be a rounded body with clockwise centrifugal grooves (28A) to add to the cyclonic effect of the cyclonic activator (78), or a rounded body with counterclockwise centrifugal grooves (28B) to add to the cyclonic effect of the cyclonic activator (78).

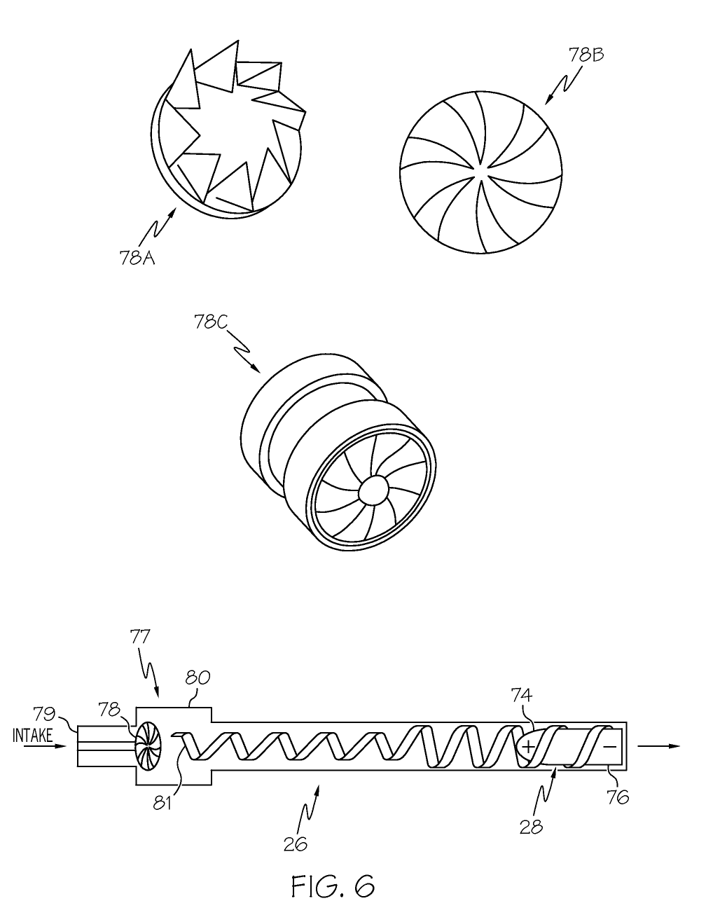

FIG. 6 shows an embodiment of a cyclonic effect pre-abatement chamber to process the incoming fuel and steam, the chamber being arranged downstream of the fuel atomizer (38) and the steam diffuser (36), upstream of the magnetic processor rod (28) and the exhaust of the devices, the pre-abatement chamber being equipped with at least an inlet aperture (79) and at least an outlet aperture (81), and internally defining a transit and expansion volume for the fumes, wherein the inlet aperture (79) and the outlet aperture (81) can be arranged respectively tangential and axial with respect to the transit and expansion volume and wherein the transit and expansion volume can define a substantially spiral path for the fumes between the inlet aperture (79) and the outlet aperture (81) suitable to generate a rotation of the fumes of no less than 360° in a clockwise or counterclockwise rotation. Elements in FIG. 6 include 1, a fixed cyclonic activator (78A), a moving cyclonic activator (78B) or a cyclonic turbine (78C). The placement of the cyclonic activator (78) in the vortex chamber (80) inside of the inner processor chamber (26) is shown.

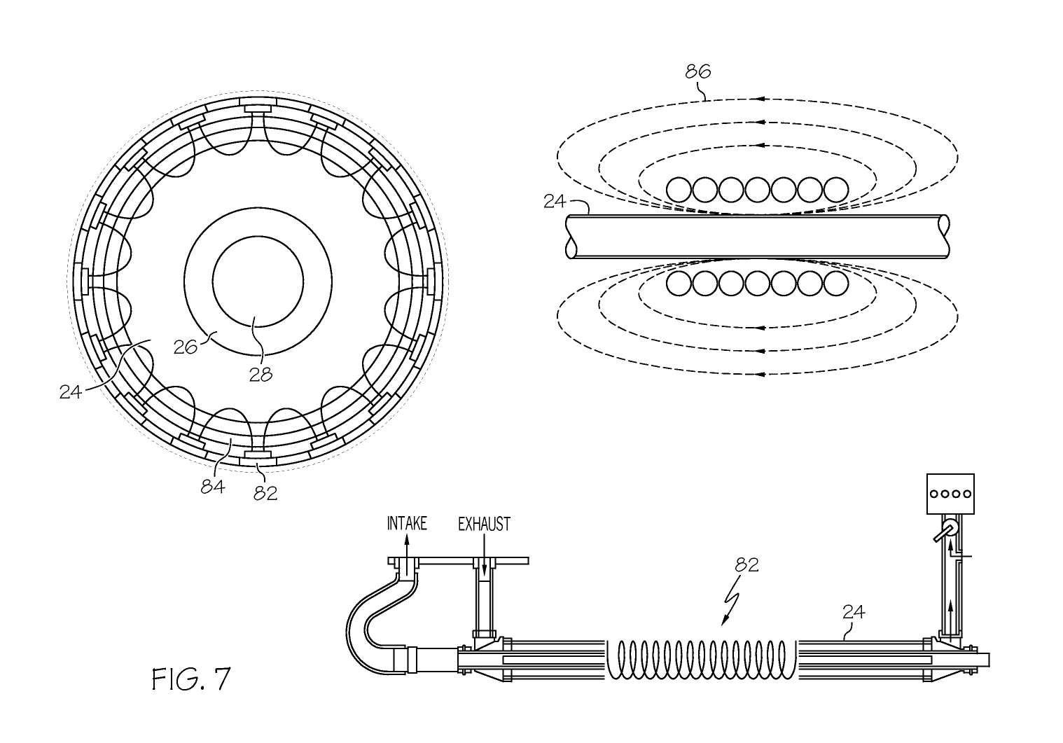

FIG. 7 shows an embodiment of the solenoid (82). The simplest magnetic configuration is a solenoid (82), a long cylinder wound with magnetic coils made up of wire producing a field with the lines of force running parallel to the axis of the cylinder. Such a field can hinder ions and electrons from being lost radiantly, but not from being lost from the ends of the solenoid (82). The magnetic field can be used to accelerate the plasma into the intake manifold (14) of the internal combustion engine (11). The electricity that is being used in the magnetic solenoid (82) can be alternating current (AC) or direct current (DC). The electricity can be of different volts or amps or watts. An adjustable switch can be added to the magnetic solenoid (82) to control the electric power, thus controlling the intensity of the magnetic field. The magnetic field created from the solenoid (82) can be used to control and intensify and speed up the plasma field going into the intake manifold (14). The solenoid (82) can be placed on the outer processor chamber (24) with a thermal blanket (84) between the solenoid (82) and the outer processor chamber (24). The wire coming off the ignition coil to the spark plug can be used as a solenoid (82), as it is already timed to the engine. Elements of FIG. 7 include a view looking into the processor chamber showing the magnetic fields, inner processor chamber (26), magnetic processor rod (28), outer processor chamber (24), thermal blanket (84) between the solenoid (82) and the outer processor chamber (24), solenoid (82) a side view the magnetic field (86) created by the solenoid (82) around the outside of the outer processor chamber (24), and the outer processor chamber (24) wound with magnetic coils to form the magnetic solenoid (82). The magnetic coil can be made up of wire.

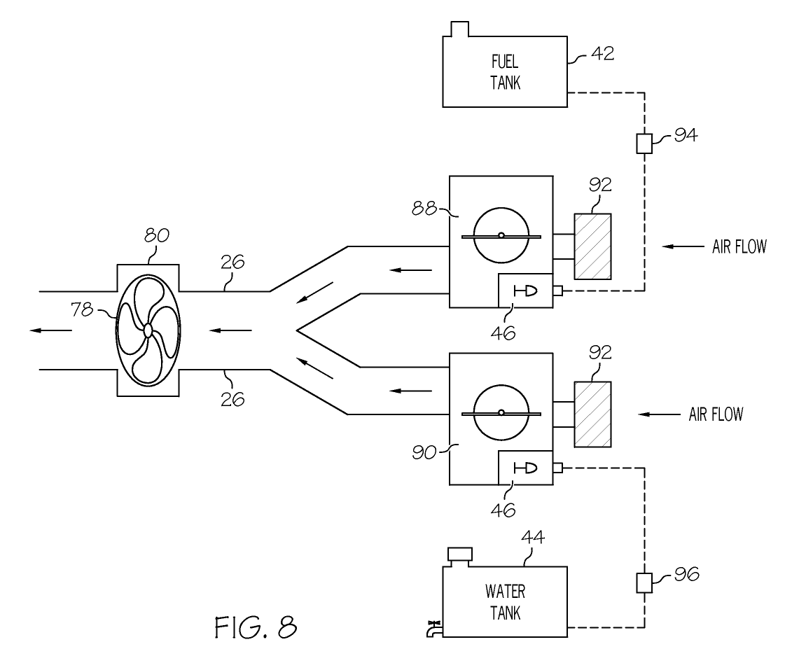

FIG. 8 illustrates that a dual carburetion system can be used instead of a steamer. The dual carburetion system can be of any operative configuration. Elements can include the cyclonic activator (78), inner processor chamber (26), vortex chamber (80), float chamber (46), fuel carburetor (88), water carburetor (90), air filter (92), fuel pump (94) or water pump (96). The pumps may be gravity fed.

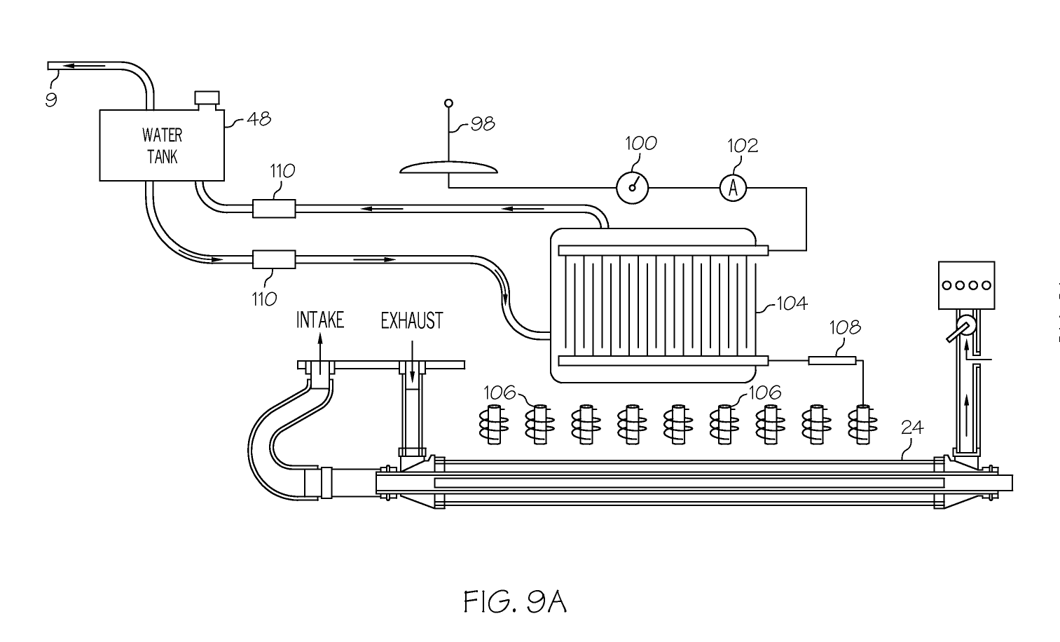

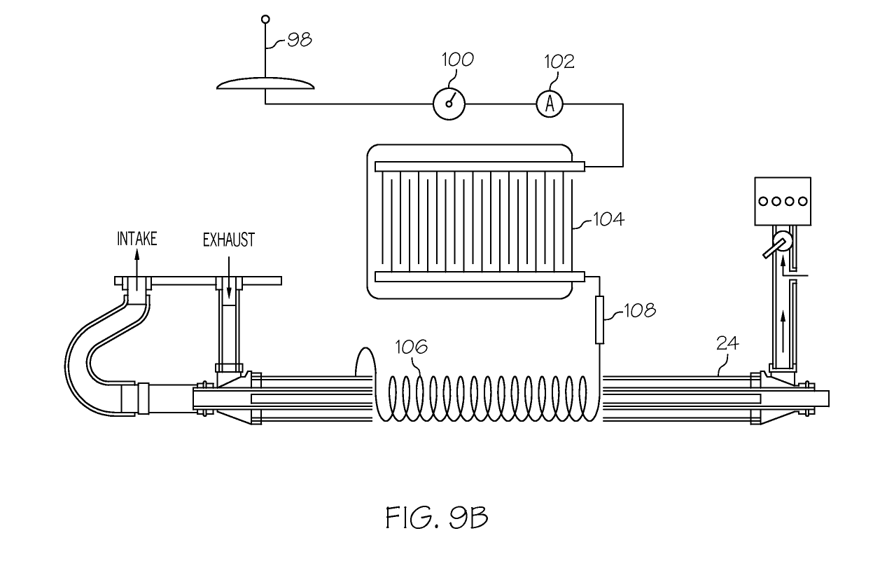

FIGS. 9A and 9B illustrate an embodiment of a sonic flux generator, a generator to convert the sonic wave (e.g., radio waves or microwaves) fields that are created from the hydrogen plasma processor that is present on the main outer processor chamber into electric energy. The electric energy then can be used to create alternative fuel (HHO) with the use of an electrolysis cell or a sonic cell that can be used to increase the efficiency of universal hydrogen plasma carburetor. The sonic flux generator can be any apparatus that realizes this effect. An exemplary embodiment for carrying this out is illustrated the accompanying drawings. Elements include, antenna (98), a potentiometer or PWM (pulse width modulator) (100), amp or volt meter (102), electrolysis cell (HHO cell) or sonic cell (104) and one or more solenoid bobbin coils (106). The solenoid bobbin coils (106) can be placed horizontally or vertically relative to the outer processor chamber (24). The solenoid bobbin coils (106) can be wired in series or parallel circuits to each other. The solenoid bobbin coils (106) can be placed around the outer processor chamber (24). Other elements include a fuse (108), a one-way valve (110) to allow the water to flow in the right direction to and from the steamer chamber (48), a hose (116) allowing for the HHO gas to be taken to the intake of the processor chamber, and a steamer chamber (48). In the potentiometer (100) a slide-wire contact can be used to create a voltage divider that can be adjusted to different settings as needed. It is this ability to make an adjustment in position that makes it possible for the potentiometer (100) to be useful in simple management tasks associated with the operation of small electrical devices. Pulse-width modulation (PWM) can be a very efficient way of providing intermediate amounts of electrical power between fully on and fully off. A simple power switch with a typical power source provides full power only, when switched on. PWM is a comparatively-recent technique, made practical by modern electronic power switches. In reference to the solenoid bobbin coil (106), coil winding is the process where iron-core transformers and inductors are commonly wound with solid copper wire insulated with enamel (this type of wire is known as magnet wire) and the process of winding the wire is commonly referred to as coil winding. A completed coil assembly with taps etc. is often called a winding. Bobbin winding is basically coil winding that is placed on a cylinder with flanges. The bobbin itself can be made from heavy paper, card, fiber board, or plastic.

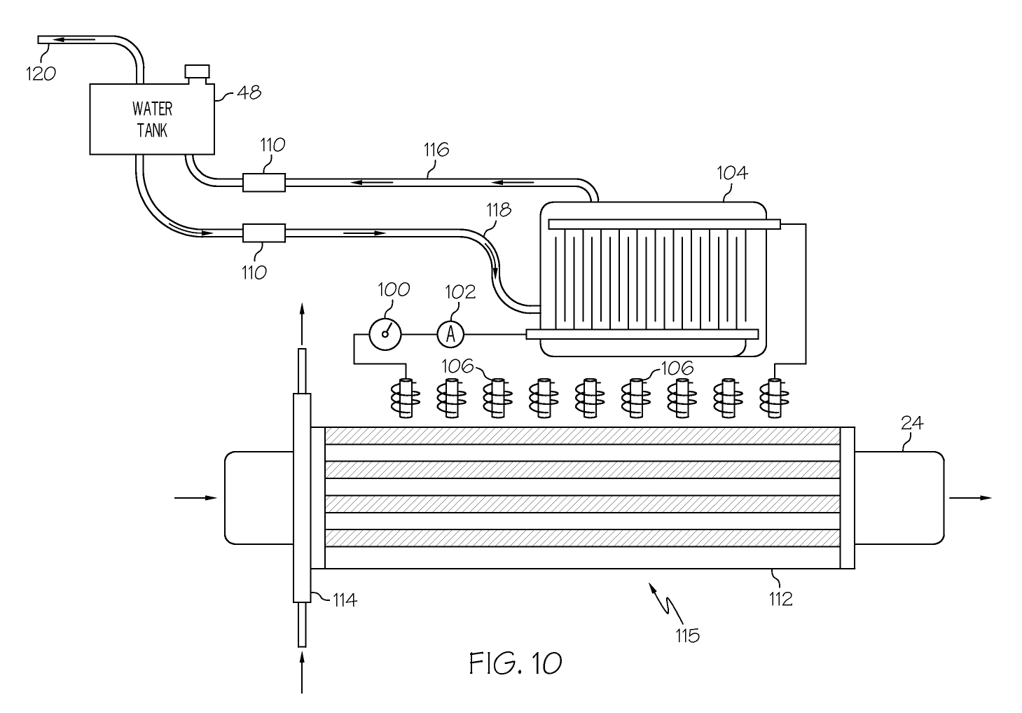

FIG. 10 depicts an exemplary embodiment of the magnetic flux generator (115) presently contemplated to convert the magnetic field that is created from the hydrogen plasma processor that is present on the main processor chamber (12) into electric energy. The electric energy then can be used to create alternative fuel (HHO) with the use of an electrolysis cell or a sonic (radio waves) cell (104). The alternative fuel can then be used to increase the efficiency of the universal hydrogen plasma carburetor. The magnetic flux generator (115) can be any apparatus that realizes a break or interferes with magnetic flux lines whether it is mechanical or electrical. An exemplary embodiment contemplated for this carrying out is illustrated the accompanying drawings. Elements include the top of the outer processor chamber (24) and one or more solenoid bobbin coils (106) that can be placed horizontally or vertically to the outer processor chamber (24). The solenoid bobbin coils (106) can be wired in series or parallel circuits to each other. A cylinder (112) made of non-magnetic metal, plastic or alloy does not allow a magnetic field to penetrate. The cylinder (112) can be of any length or size to go around 360° of the outer processor chamber (24). The cylinder (112) can have slots along its length to allow the magnetic field through. The cylinder (112) can be set in motion with the use of unit (114) that allows the mechanical movement of the non-magnetic cylinder by means of the exhaust gases, thereby creating a magnetic flux generator. The cylinder (112) can be a flat non-magnetic metal, plastic or alloy that does not allow the magnetic field to be penetrated that can be of any suitable length or size. The flat plate can have slots along its length to allow the magnetic field through. The flat plate can comprise one or more parts that work like moving shutters by being placed horizontally to the outer processor chamber (24). The moving shutter can be set in motion with the use of exhaust gases or any other way to achieve the effect. Other elements include the electrolysis cell (HHO cell) or sonic cell (104), amp or volt meter (102), a potentiometer or pulse width modulator (100), a one-way valve (110) to allow the water to flow in the right direction, a steamer chamber (48), a hose (116) brings HHO gas to the steamer chamber (48), a hose (118) allowing the flow of water back to the electrolysis cell (104), a hose (120) allowing the HHO gas to be taken to the intake of the pressure chamber.

It should be understood, of course, that the foregoing relates to exemplary embodiments of the invention and that modifications may be made without departing from the spirit and scope of the invention as set forth in the following claims.

We claim:

1. A device for pretreating fuel to provide a suitable fuel for combustion in a fuel burning apparatus having a fuel intake system and an exhaust system, the device comprising:
a volatilization chamber for volatilizing the fuel in the volatilization chamber;
a heated processor tube through which the volatilized fuel flows;
a cyclonic activator;
a magnetic processor rod mounted in the processor tube around which the volatilized fuel flows as it flows through a reactor tube;
a space between the magnetic processor rod and the heated processor tube through which the volatilized fuel flows forming a reaction zone thereby creating reacted fuel;
a magnetic flux generator presently that converts a magnetic field that is into electric energy, wherein said electric energy can be used to create alternative fuel with the use of an electrolysis cell, and wherein the alternative fuel can then be used to increase the efficiency of the device and inlet means for directing the reacted fuel into the intake system of the fuel burning apparatus.

2. The device according to claim 1 further comprising:
an exhaust conduit in fluid communication with the exhaust system of the fuel burning apparatus to receive exhaust from the fuel burning apparatus and wherein the heated processor tube is mounted in the exhaust conduit and is heated by exhaust gases passing through the exhaust conduit.

3. The device according to claim 2, wherein the processor tube is mounted in the exhaust conduit such that flow of volatilized fuel through the processor tube is countercurrent to the flow of exhaust gases through the exhaust conduit.

4. The device according to claim 3, wherein the volatilization chamber is heated.

5. The device according to claim 4, wherein the volatilization chamber is connected to the exhaust conduit downstream of the reactor tube, whereby heat from the exhaust gases heats the volatilization chamber.

6. The device according to claim 5, further comprising an exhaust bypass means for diverting a portion of the exhaust gas from the exhaust conduit through the fuel.

7. The device according to claim 6 wherein the exhaust bypass means includes a steamer in the volatilization chamber for bubbling the exhaust diverted into the volatilization chamber.

8. The device according to claim 1 wherein the processor tube is mounted coaxially and in spaced relationship in the exhaust conduit, and the reactor rod is mounted coaxially and in spaced relationship in the reactor tube, the spaced relationship between the reactor rod and the reactor tube forming the reaction zone.

9. A pretreater device for pretreating an alternate fuel to provide a suitable fuel for an internal combustion engine, the internal combustion engine having a fuel intake system and an exhaust system, the device comprising:
an exhaust conduit having a first end and a second end, the first end being connected in fluid communication with the exhaust system of the internal combustion engine to receive exhaust from the internal combustion engine;
an exhaust plenum at the second end of the exhaust conduit;
a volatilization chamber interposed in the exhaust plenum, the volatilization chamber receiving thermal energy from an exhaust passing through the exhaust plenum;
volatilization means for volatilizing the fuel in the volatilization chamber;
exhaust bypass means for diverting a portion of the exhaust from the exhaust conduit through the alternate fuel;
removal means for removing the volatilized fuel from the volatilization chamber;
a processor tube mounted in the exhaust conduit through which the volatilized alternate fuel flows;
a magnetic processor rod mounted in the processor tube around which the volatilized fuel flows as it flows through the processor tube, the space between the magnetic processor rod and the processor tube through which the volatilized fuel flows forming a reaction zone; and
a magnetic solenoid for accelerating the reacted fuel into the intake system of the internal combustion engine.

10. The pretreater device according to claim 9 wherein the exhaust bypass means includes a steamer plate in the volatilization chamber for bubbling the exhaust diverted into the volatilization chamber.

11. The pretreater device according to claim 9 wherein said processor tube is mounted coaxially and in spaced relationship in the exhaust conduit, and the magnetic processor rod is mounted coaxially and in spaced relationship in the processor tube, the spaced relationship between the magnetic processor rod and the processor tube forming the reaction zone.

12. The pretreater device according to claim 9 wherein the fuel is selected from a hydrocarbon other than a conventional fuel, the hydrocarbon being selected from the group consisting of crude oil, waste petroleum, used paint thinner, used motor oil, and organic solvents.

14. The pretreater device according to claim 9 including control means for selectively controlling each of the exhaust bypass means, the removal means, and the inlet means.

15. A method for pretreating a fuel and water to make it usable in fuel burning equipment comprising the steps of:
selecting a fuel;
placing the fuel in a volatilization chamber;
volatilizing the fuel;
pretreating the volatilized fuel by passing the volatilized fuel through a processor tube with a processor rod mounted therein to form a reaction zone between the reactor rod and the reactor tube, the reactor tube being heated to produce a plasma fuel; and
accelerating the plasma fuel into the internal combustion engine through the use of a magnetic field generated by a solenoid around the processor tube.
